(19) United States
(12) Patent Application Publication
(10) Pub. No.: US 2011/0000468 A1
(43) Pub. Date: Jan. 6, 2011

(54) DEVICE FOR FEEDING FUEL

(76) Inventors: Radek Malec, Ceske Budejovice (CZ); Petr Janis, Krnov (CZ); Zdenek Belda, Jindrichuv Hradec (CZ); Juergen Gras, Bietigheim-Bissingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/919,868

(22) PCT Filed: Dec. 18, 2008
(86) PCT No.: PCT/EP08/67870

§ 371 Date: Aug. 27, 2010

(30) Foreign Application Priority Data
Feb. 28, 2008 (DE) 10 2008 000 437.5

(51) Int. Cl. F02M 37/04

(52) U.S. Cl. 123/509

(57) ABSTRACT

Devices for feeding fuel are already known which have a storage pot which can be filled by a suction jet pump. The storage pot has a pot base with an intake opening which opens into an intake chamber of the suction jet pump and through which the suction jet pump sucks in fuel. The intake chamber is fluidically connected to the storage pot via a mixer duct. A non-return valve is provided in the intake opening in order to prevent fuel from back-flowing. Considerable flow turbulence occurs within the suction jet pump, which flow turbulence can lead, in particular in the case of heated fuel, referred to as hot petrol, to the formation of gas bubbles. The delivery capacity of the suction jet pump is considerably reduced by the gas bubbles, with the result that under certain operating conditions the storage pot is not sufficiently filled and can run empty. In the device according to the invention, the flow turbulence is reduced. The invention provides that an oblique ramp for guiding the flow with little turbulence is provided at the junction with the mixer duct on the pot base of the storage pot inside the intake chamber.

### PRIOR ART

The invention is based on a device for feeding fuel as generically defined by the preamble to the main claim.

One such device for feeding fuel is already known from U.S. Pat. Nos. 5,330,475 A1 and 4,860,714 A1, having a storage pot that can be filled by means of a suction jet pump and that has a pot bottom with an intake opening which discharges into an intake chamber of the suction jet pump and through which the suction jet pump aspirates fuel; the intake chamber communicates fluidically with the storage pot via a mixing conduit. In the intake opening, a check valve is provided, for preventing a return flow of fuel. Inside the suction jet pump, considerable flow turbulence occurs, which especially with heated fuel, so-called hot gasoline, leads to the formation of gas bubbles. The gas bubbles reduce the feeding capacity of the suction jet pump considerably, so that in certain operating states, the storage pot cannot be adequately filled and can run empty.

### ADVANTAGES OF THE INVENTION

The device according to the invention having the definitive characteristics of the body of the main claim has the advantage over the prior art that the flow turbulence is reduced, and the intake capacity of the suction jet pump is increased by the elimination of gas bubble formation, in that at the pot bottom of the storage pot, inside the intake chamber, at the transition to the mixing conduit. an oblique ramp for low-turbulence flow guidance is provided. The intake opening and the inlet into the mixing conduit are disposed in different planes, which are connected to one another by means of the oblique ramp according to the invention. Because of the lesser flow turbulence in the suction jet pump, with heated fuel fewer bubbles in the fuel occur, so that more fuel is fed into the storage pot.

By the provisions recited in the dependent claims, advantageous refinements of and improvements to the device defined by the main claim are possible.

In one advantageous feature, the oblique ramp merges continuously with the pot bottom. In this way, flow turbulence is avoided, so that with the same driven stream quantity, a higher intake capacity is attained.

It is very advantageous if the intake chamber and the mixing conduit are embodied on a housing of the suction jet pump, and the intake chamber is open toward the pot bottom. In the disposition of the intake chamber on the pot bottom, a closed chamber is thus achieved, which communicates fluidically with a fuel tank via the intake opening and with the storage pot via the mixing conduit.

It is also advantageous that the housing of the suction jet pump has a steplike transition, from the intake chamber to the mixing conduit, that is adjoined by the oblique ramp. The oblique ramp is embodied separately on the pot bottom and separately from the housing of the suction jet pump, and once the housing of the suction jet pump is secured to the pot bottom, a suction jet pump of the invention is formed that has an essentially steady transition from the intake chamber into the mixing conduit.

It is especially advantageous if the oblique ramp is embodied in one piece with the pot bottom of the storage pot, since in this way the oblique ramp can be produced economically by injection molding together with the storage pot. The pot bottom of the storage pot therefore has an oblique ramp embodied on it.

It is furthermore advantageous if the housing of the suction jet pump is fixed on the pot bottom by retention means.

It is also advantageous if a receptacle for securing the suction jet pump is provided on the pot bottom, since the housing of the oblique ramp in this way can be secured especially simply to the pot bottom of the storage pot.

It is furthermore advantageous if the mixing conduit of the suction jet pump extends in the direction of the pot bottom, since the efficiency of the suction jet pump is greater in this version than when there is a vertically disposed mixing conduit.

### DRAWINGS

One exemplary embodiment of the invention is shown in simplified form in the drawings and is described in further detail in the ensuing description.

FIG. 1 in section shows a device for feeding fuel, with a suction jet pump of the invention; and

FIG. 2 is a detail of the pot bottom of the storage pot of FIG. 1.

### DESCRIPTION OF THE EXEMPLARY EMBODIMENT

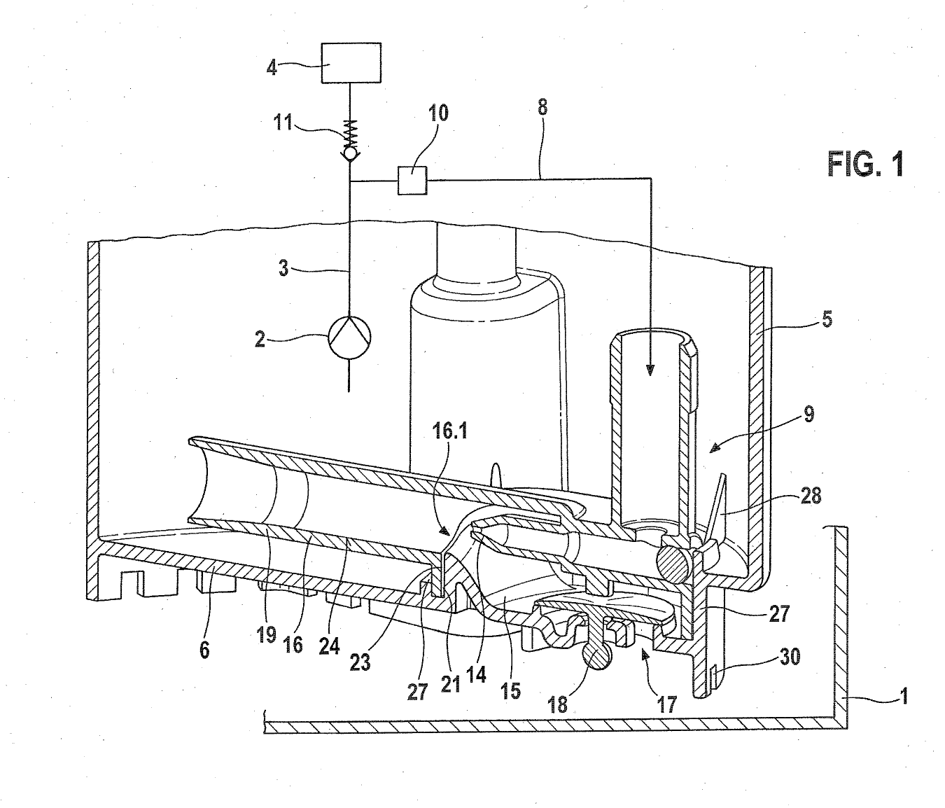

FIG. 1 in section shows a device for feeding fuel, with a suction jet pump of the invention.

The device for feeding fuel is disposed in a fuel tank 1 and by means of a feed unit 2 feeds fuel from the fuel tank 1 at elevated pressure via pressure line 3 to an internal combustion engine 4. The feed unit 2 is disposed in a storage pot 5, which keeps enough fuel on hand for the feed unit 2 so that the feed unit can aspirate fuel even at low fill levels in the fuel tank 1 and during acceleration, braking, cornering, and/or traveling uphill and downhill. The storage pot 5 has a pot bottom 6. A drive line 8, which drives a suction jet pump 9 for active filling of the storage pot 5, branches off from the pressure line 3. A pressure regulating valve 10 may be provided in the pressure line 3 or the drive line 8; not until past a predetermined pressure in the pressure line 3 does it allow fuel to flow out of the pressure line 3 into the drive line 8. Downstream of the branching point of the drive line 8, a check valve 11 is provided in the pressure line 3; it prevents a return flow of fuel. The drive line 8 discharges via what is for instance a narrowed jet outlet 14 into an intake chamber 15 of the suction jet pump 9. The intake chamber 15 is adjoined by a mixing conduit 16, which is disposed in an imaginary extension of the jet outlet 14, in such a way that a fluid jet emerging from the jet outlet 14 of the drive line 8 reaches the mixing conduit 16 in a straight line via the intake chamber 15. The mixing conduit 16 extends horizontally in the direction of the pot bottom 6.

The mode of operation of the suction jet pump 9 is well known, so that it need be described here only briefly: Via the drive line 8 and its jet outlet 14, a driving flow is introduced in jet form into the intake chamber 15. The drive jet of the drive line 8 entrains surrounding fuel from the intake chamber 15 into the mixing conduit 16, so that a feeding flow into the storage pot 5 is established via the mixing conduit 16. In the intake chamber 15, an underpressure occurs, which causes a replenishing flow of fuel, via an intake opening 17 of the intake chamber 15, out of the fuel tank 1 into the intake chamber 15. At the intake opening 17, a valve member 18 is provided, which cooperates with the intake opening 17 and with it forms a check valve.

The intake chamber 15 and the mixing conduit 16 are embodied on a housing 19 of the suction jet pump 9, and the intake chamber 15 is open toward the pot bottom 6. The part of the housing 19 having the intake chamber 15 is disposed on the pot bottom 6 and encloses the intake opening 17. As a result, a closed intake chamber 15 is attained, which communicates fluidically with the fuel tank 1 via the intake opening 17 and with the storage pot 5 via the mixing conduit 16. A portion of the drive line 8 is also embodied on the housing 19 and discharges with the narrowed jet outlet 14 into the intake chamber 15.

According to the invention, it is provided that at the pot bottom 6 of the storage pot 5, inside the intake chamber 15, at the transition 23 to the mixing conduit 16, an oblique ramp 20 for low-turbulence flow guidance is provided. The oblique ramp 20 reduces the turbulence in the flow, so that particularly with so-called hot gasoline, fewer gas bubbles occur inside the suction jet pump 9. The oblique ramp 20 acts as a so-called deflector and deflects the flow with little turbulence.

The intake opening 17 and a lower edge 24, oriented toward the pot bottom 6, on the inlet 16.1, toward the intake chamber, into the mixing conduit 16 are disposed in different planes, and the planes are connected to one another by means of the oblique ramp 20. The oblique ramp 20 rises essentially steadily from the plane having the intake opening 17 to the plane having the lower edge 24. However, the oblique ramp 20 could also be embodied in steplike fashion, rising in a plurality of stages. The oblique ramp 20 merges essentially continuously with the pot bottom 6. The housing 19 of the suction jet pump 9 itself has a steplike transition 23 from the intake chamber 15 to the mixing conduit 16, and after the housing 19 is secured to the pot bottom 6, the oblique ramp 20 of the pot bottom 6 and the lower edge 24 at the inlet 16.1 of the mixing conduit 16 adjoin one another essentially continuously. Viewed in the flow direction, the mixing conduit 16 with its lower edge thus adjoins the highest point of the oblique ramp 20, and at the transition between the oblique ramp 20 and the mixing conduit 16, a connection gap 21 is formed. The wall thickness of the pot bottom 6 in the vicinity of the oblique ramp 20 is embodied as approximately the same as in the rest of the pot bottom 6.

In the exemplary embodiment, the oblique ramp 20 is embodied in one piece with the pot bottom 6 of the storage pot 5. However, the oblique ramp 20 could also be a separate part, which is secured to the pot bottom 6 or to the housing 19 of the suction jet pump 9. It can equally well be provided that the oblique ramp 20 is embodied in one piece with the housing 19 of the suction jet pump 9.

The housing 19 is fixed to the pot bottom 6 by means of retention means 28. In the exemplary embodiment, a receptacle 27 for the part of the housing 19 having the intake chamber 15 is provided on the pot bottom 6 of the storage pot 5. The receptacle 27 is adapted to the shape of the intake chamber 15, so that the housing 19 can be inserted with the intake chamber 15 into the receptacle 27. The suction jet pump 9 is fixed, for instance locked, in the receptacle 27 by means of the retention means 28. The receptacle 27 surrounds the intake opening 17.

A coarse filter 30, for instance, is embodied on the side of the pot bottom 6 toward the fuel tank 1; it filters the fuel, aspirated by the suction jet pump 9, upstream of the intake opening 17.

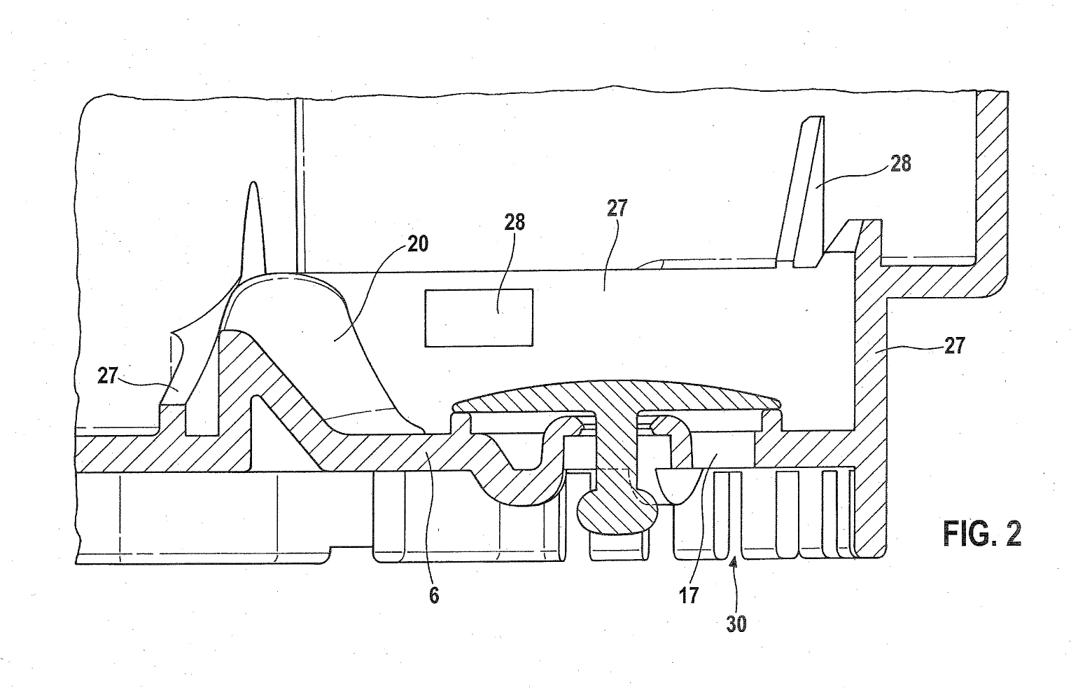

FIG. 2 is a detail of the pot bottom of the storage pot of FIG. 1.

In the device of FIG. 2, the parts that remain the same or function the same as in the device of FIG. 1 are identified by the same reference numerals.

1-10. (canceled)

11. A device for feeding fuel, having a storage pot that can be filled by means of a suction jet pump and that has a pot bottom with an intake opening, which discharges into an intake chamber of the suction jet pump and through which intake chamber the suction jet pump aspirates fuel, the intake chamber being fluidically in communication with the storage pot via a mixing conduit, and at the pot bottom of the storage pot, inside the intake chamber, at a transition to the mixing conduit, an oblique ramp for low-turbulence flow guidance is provided.

12. The device as defined by claim 11, wherein the intake opening and the inlet into the mixing conduit are disposed in different planes and the intake opening and the inlet into the mixing conduit are connected to one another by means of the oblique ramp.

13. The device as defined by claim 11, wherein the oblique ramp merges continuously with the pot bottom.

14. The device as defined by claim 12, wherein the oblique ramp merges continuously with the pot bottom.

15. The device as defined by claim 11, wherein the intake chamber and the mixing conduit are embodied on a housing of the suction jet pump, and the intake chamber is open toward the pot bottom.

16. The device as defined by claim 12, wherein the intake chamber and the mixing conduit are embodied on a housing of the suction jet pump, and the intake chamber is open toward the pot bottom.

17. The device as defined by claim 13, wherein the intake chamber and the mixing conduit are embodied on a housing of the suction jet pump, and the intake chamber is open toward the pot bottom.

18. The device as defined by claim 14, wherein the intake chamber and the mixing conduit are embodied on a housing of the suction jet pump, and the intake chamber is open toward the pot bottom.

19. The device as defined by claim 15, wherein the housing of the suction jet pump has a steplike transition, from the intake chamber to the mixing conduit, that is adjoined by the oblique ramp.

20. The device as defined by claim 16, wherein the housing of the suction jet pump has a steplike transition, from the intake chamber to the mixing conduit, that is adjoined by the oblique ramp.

21. The device as defined by claim 17, wherein the housing of the suction jet pump has a steplike transition, from the intake chamber to the mixing conduit, that is adjoined by the oblique ramp.

22. The device as defined by claim 18, wherein the housing of the suction jet pump has a steplike transition, from the intake chamber to the mixing conduit, that is adjoined by the oblique ramp.

23. The device as defined by claim 11, wherein the oblique ramp is embodied in one piece with the pot bottom of the storage pot.

24. The device as defined by claim 14, wherein the oblique ramp is embodied in one piece with the pot bottom of the storage pot.

25. The device as defined by claim 11, wherein the housing of the suction jet pump is fixed on the pot bottom by retention means.

26. The device as defined by claim 11, wherein a receptacle for securing the suction jet pump is provided on the pot bottom.

27. The device as defined by claim 14, wherein a receptacle for securing the suction jet pump is provided on the pot bottom.

28. The device as defined by claim 26, wherein the receptacle annularly surrounds the intake opening.

29. The device as defined by claim 27, wherein the receptacle annularly surrounds the intake opening.

30. The device as defined by claim 11, wherein the mixing conduit of the suction jet pump extends toward the pot bottom.
